(19) United States
(12) Patent Application Publication
(10) Pub. No.: US 2026/0098185 A1
(43) Pub. Date: Apr. 9, 2026

(54) COMPLIANT BACKING STRUCTURE FOR GECKO MATERIAL AND USES THEREOF

(71) Applicant: UNIVERSITY OF SOUTHERN CALIFORNIA, Los Angeles, CA (US)

(72) Inventors: David Barnhart, Los Angeles, CA (US); Madeline Stratton, Los Angeles, CA (US)

(21) Appl. No.: 19/353,187

(22) Filed: Oct. 8, 2025

Related U.S. Application Data
(60) Provisional application No. 63/704,551, filed on Oct. 8, 2024.

(51) Int. Cl. C09J 7/26; B25J 15/00; B32B 3/30; B32B 5/18; B32B 25/20; C09J 5/00; C09J 7/25

(52) U.S. Cl. CPC C09J 7/26; B25J 15/008; B32B 3/30; B32B 5/18; B32B 25/20; C09J 5/00; C09J 7/25; B32B 2307/536; B32B 2307/72; B32B 2307/7376; B32B 2405/00; C09J 2203/358; C09J 2301/16; C09J 2301/31; C09J 2400/243; C09J 2483/006

(57) ABSTRACT

Disclosed are dry adhesive materials having improved adhesion properties. In some aspects, the dry adhesive material includes: a gripping layer comprising an adhesive surface defining a plurality of shear-deformable adhesion micro- or nanostructures; and a compliant backing layer operatively coupled with the gripping layer such that a loading force applied normal to the compliant backing layer causes the plurality of shear-deformable adhesion micro- or nanostructures to electrostatically engage with a target surface.

### CROSS-REFERENCE TO RELATED APPLICATIONS

This application claims priority to and benefit under 35 U.S.C. § 119 (e) of U.S. Provisional Patent Application Ser. No. 63/704,551, filed Oct. 8, 2024, which is hereby incorporated by reference herein in its entirety.

### BACKGROUND

In nature, geckos demonstrate the ability to adhere themselves to various surfaces via the unique nano-scale structures of their feet. Gecko feet demonstrate a strong and directional type of dry adhesion which researchers have attempted to replicate in the lab. These synthetic gecko materials (or gecko “tiles”) use van der Waals forces and directional micro-wedges to adhere to surfaces. When the adhesive's micro-wedges are loaded in shear, the gecko material demonstrate dry adhesion to a variety of surfaces.

However, existing dry adhesive materials are limited by their relatively low adhesive strength. Thus, there is a need for dry adhesive materials capable of exhibiting high adhesive performance.

### SUMMARY

In accordance with the purposes of the disclosed systems, devices, and methods, as embodied and broadly described herein, the disclosed subject matter relates to dry adhesive materials and uses thereof. The dry adhesive materials can include: a gripping layer comprising an adhesive surface defining a plurality of shear-deformable adhesion micro- or nanostructures; and a compliant backing layer operatively coupled with the gripping layer such that a loading force applied normal to the compliant backing layer causes the plurality of shear-deformable adhesion micro- or nanostructures to electrostatically engage with a target surface.

In some aspects, the compliant backing layer has a thickness of 1 centimeter (cm) or more (e.g., 1.5 cm or more, 2 cm or more, 2.5 cm or more, 3 cm or more, 3.5 cm or more, 4 cm or more, 4.5 cm or more, or 5 cm or more). In some aspects, the compliant backing layer has a thickness of from 1 cm to 5 cm (e.g., from 2 cm to 5 cm, from 2 cm to 4 cm, or from 2 cm to 3 cm). In some aspects, the compliant backing layer comprises a material having a compressive stiffness of 1 MPa or less (e.g., 500 kPa or less, 400 kPa or less, 300 kPa or less, 200 kPa or less, 100 kPa or less, 50 kPa or less, or 25 kPa or less).

In some aspects, the compliant backing layer comprises a material having a Shore A hardness of 50 or less (e.g., 40 or less, 30 or less, 20 or less, or 10 or less).

In some aspects, the compliant backing layer comprises a material having an average density of 100 kg/m3 or less (e.g., 75 kg/m3 or less, 50 kg/m3 or less, 40 kg/m3 or less, 30 kg/m3 or less, 20 kg/m3 or less, 10 kg/m3 or less).

In some aspects, the compliant backing layer comprises a porous foam material.

In some aspects, the compliant backing layer comprises a material selected from the group consisting of elastomers and polymeric foams.

In some aspects, the polymeric foam comprises polyurethane foam, polyurea foam, polyolefin foam, polyester foam, polystyrene foam, polyether foam, or a copolymer thereof, or a combination thereof.

In some aspects, the polymeric foam comprises an open cell foam. In some aspects, the polymeric foam comprises a closed-cell foam.

In some aspects, the compliant backing layer comprises a soft silicone rubber (e.g., silicon having a hardness (Shore A) of 50 or less, 40 or less, 30, or less, 20 or less, or 10 or less).

In some aspects, the plurality of shear-deformable adhesion micro- or nanostructures comprise directionally-biased micro-wedges.

In some aspects, the gripping layer comprises a flexible substrate disposed between the adhesive surface and the compliant backing layer.

In some aspects, a peak shear force of the dry adhesive material is at least 10 N/cm² or more (e.g., 15 N/cm² or more, 20 N/cm² or more, or 25 N/cm² or more) measured at a normal force of 1 N.

In some aspects, a peak shear force of the dry adhesive material is at least 2 times greater (e.g., at least 2.5 times greater, at least 3 times greater) than a peak shear force of a dry adhesive material without a compliant backing.

Also disclosed herein are end effectors comprising one or more moveable members, wherein at least a portion of an outer surface of the one or more moveable members comprises the any of the described dry adhesive materials.

The present disclosure further provides robotic systems comprising the end effectors described herein. In some aspects, the robotic system includes a robotic arm comprising the end effector. In some aspects, the robotic arm is operatively coupled to a motor. In some aspects, the motor is configured to actuate the end effector to thereby impose a normal force on the dry adhesive.

Also described herein are methods of gripping an object. In some aspects, the method includes: positioning the end effectors described herein proximate to an object; and actuating said end effector (e.g., via an applied normal force) to cause at least a portion of the dry adhesive material to contact the object to thereby secure (e.g., temporarily) the object to the end effector. In some aspects, the method further includes moving the object from a first location to a second location. In some aspects, the method further includes disengaging said end effector to thereby release the object (e.g., at the second location). In some aspects, the object has a uniform surface area. In some aspects, the object has a non-uniform surface area.

Additionally described are textiles comprising the any of the dry adhesive materials described herein.

A number of embodiments of the disclosure have been described. Nevertheless, it will be understood that various modifications may be made without departing from the spirit and scope of the invention. Accordingly, other embodiments are within the scope of the following claims.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### BRIEF DESCRIPTION OF THE DRAWINGS

The skilled person in the art will understand that the drawings described below are for illustration purposes only.

FIG. 1 shows an example structure of a dry adhesive material according to one aspect of the present disclosure.

FIG. 2 shows (Panel a) the microscopic structure of gecko adhesive. (Panel b) When put under shear load, more gecko adhesive comes into contact with a surface, increasing its adhesion. (Panel c) an enlarged view depicting the directional nature of the microscopic wedges.

FIG. 3 shows a comparison of conventional rigid dry adhesives with those having a compliant structure. (Panel a) The gecko tile is mounted to a rigid backing structure which is not compliant (for example, a 3-D printed, thin plastic prism). The load is applied evenly across the gecko tile's surface area and directly to the tile. Then, a pull force is applied which loads the gecko tile in shear, causing it to adhere to the target. (Panel b) The applied load first contacts a compliant backing structure. Then, the pull force is applied to the gecko tile. This configuration results in a dramatic increase in the peak shear force before slippage across a target's surface.

FIG. 4 shows the peak shear force between a gecko tile and a target before slipping is consistently much greater after the introduction of a compliant backing structure (here, a sponge was used) under the gecko tile for different normal load values.

FIG. 5 depicts a plot showing force delivered to the target (per quadrant, for a 500 g load) plotted against the peak shear force obtained from the gecko tile before slipping from the target surface. Silicon 10 and Silicon 30 are two silicon prisms of Shore hardness 10 and 30, respectively. Using a rigid backing structure under the gecko tile results in minimal shear gains. Remarkably, adding a compliant backing structure of either sponge, Silicon 10, or Silicon 30 resulted in more than twice the amount of shear capability under the same loading conditions compared to the rigid backing structure.

FIG. 6 shows gecko tiles under a microscope with different backing structures. As a load is introduced, the micro-wedges of the gecko adhesive flatten such that more of the adhesive material contacts a surface as load is increased. Photos taken at the USC SERC lab.

FIG. 7 shows peak shear force versus normal force delivered to a gecko tile for the rigid and sponge backing structures. Each data point corresponds to a certain load value (100 g, 200 g, 300 g, etc.). The compliant backing structure caused less normal force to be delivered to the gecko tile compared to the rigid backing structure with the same load. However, for the same applied load, the addition of a compliant backing structure permitted a much greater peak shear force to be obtained from the gecko tile compared to the rigid backing structure.

FIG. 8 shows an example application of dry adhesive materials with compliant backing structures for a robotic gripper. The applied normal force is the force from the robotic end-effector delivered to the target. When the gecko tiles are engaged, there exists a shear force between the gecko tile and the target. The opposing shear force vectors allow for firm adherence to the target (and pull it to the left, in the figure). The compliant material results in a greater shear force to exist here. The greater shear force between the gecko tile and the target, the greater adherence to any target.

FIG. 9. Left: Three 3D-printed surfaces to test gecko compliance to different geometries: an irregular surface (left), a curved surface (right), and a flat surface (bottom). The surfaces are coated to ensure smooth, identical surface conditions. Right: Depictions of three backing structures made from sponge, silicone, and a rigid prism.

FIG. 10. Loading set-up for the rigid backing structure on the flat and curved surfaces. Notice that the flexible 2×2 force-sensitive resistor (FSR) matrix is placed between the gecko tile and target, which means the gecko adhesive does not make contact with the target in this experiment as only the force delivered from the gecko to the target when normally loaded.

FIG. 11. Force delivered (in grams) to a surface as load applied to the gecko tile is increased.

FIG. 12. Variation in distribution of applied load on a gecko tile for different backing structure options.

FIG. 13. Pulling on the gecko tile at 180 degrees corresponds to the maximum adhesive strength of that gecko tile. This is due to the directional nature of the tile's micro-wedges which load in shear most effectively in one direction.

FIG. 14. Experimental set-up example for the sponge backing structure and flat target at a 300 g load. To ensure pull in the plane of the gecko tile, pieces of paper are used as levelling. The target is attached to a stiff piece of cardboard, which is then clamped to the bench. A Vernier force sensor is hooked to the gecko adhesive and pulled horizontally away from the adhesive's surface.

FIG. 15. The maximum shear force a gecko tile can produce before slipping off a surface, F_{s,max}, is extracted using a Vernier force sensor. F_{s,max} corresponds to the maximum pull force value of each run. These pull tests correspond to the rigid backing structure with a 500 g load on the flat target.

FIG. 16. The use of a compliant (sponge) backing structure causes better adhesive performance across all studied surface geometries. Maximum adhesive force obtained generally increases as a function of load. Note the different y-axes used in this figure.

FIG. 17. Gains in maximum adhesive strength with a compliant backing structure across all surfaces as applied load on the gecko tile increases.

FIG. 18. In the figure, each point represents one value from the force sensor matrix. All four force values are a proxy for contact area engaged across the adhesive. These points were plotted against the maximum adhesive strength of the gecko tile gathered via pull tests. All compliant options out-perform the rigid backing structure option and increase the adhesive strength of the tile. These tests were done against the flat surface for a 500 g load.

FIG. 19. Normal force delivered to a gecko tile versus the maximum shear force produced from that tile. The figure demonstrates gains in shear adhesive force for the same normal load with the use of a compliant (sponge) backing structure.

FIG. 20. Maximum shear force for the compliant sponge and rigid backing structures as the gecko tile's surface area of contact with an object is varied.

FIG. 21. Example illustration of how a geometrically irregular target can cause off-nominal loading of a gecko tile on a compliant backing structure.

FIG. 22. A depiction of the REACCH gecko-gripper system used as a testbed in air-bearing platform (ABP) adhesion experiments. The blue rectangles mark the location of force sensors underneath each gecko tile. The gecko adhesives sit atop the force sensors on each arm link. The yellow arcs are depictions of flex sensors placed between some links.

FIG. 23. Both REACCH and the target are attached to floatbots which allow them to “float” on the SERC ABP, a 3-DOF quasi-frictionless testbed. REACCH's limbs are deployed to grab two different targets as compliance-introduction strategies are tested. The study recorded the number of force sensors engaged per trial. For the irregularly-shaped box target, compliant backing structures result in greater force sensor engagement (i.e., total surface area of contact) between the gripper and the target compared to the rigid backing structures. This implies better gripping force on the target.

FIG. 24. Depiction of the typical behavior of the rigid and compliant backing structures when applied to the cylindrical and box targets. The compliant backing structures result in better adhesion to the irregularly-shaped box target.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a layer”, includes, but is not limited to, one or more such compounds, compositions, or layers, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. As used herein, the term “plurality” means two or more.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The term “anisotropic” means having at least one property that differs in value when measured in at least one different direction.

One skilled in the art will readily appreciate that the present invention is well adapted to carry out the objects and obtain the ends and advantages mentioned, as well as those inherent therein. The devices, device elements, methods, and materials described herein as presently representative of preferred embodiments are exemplary and are not intended as limitations on the scope of the invention. Changes therein and other uses will occur to those skilled in the art and are intended to be encompassed within this invention.

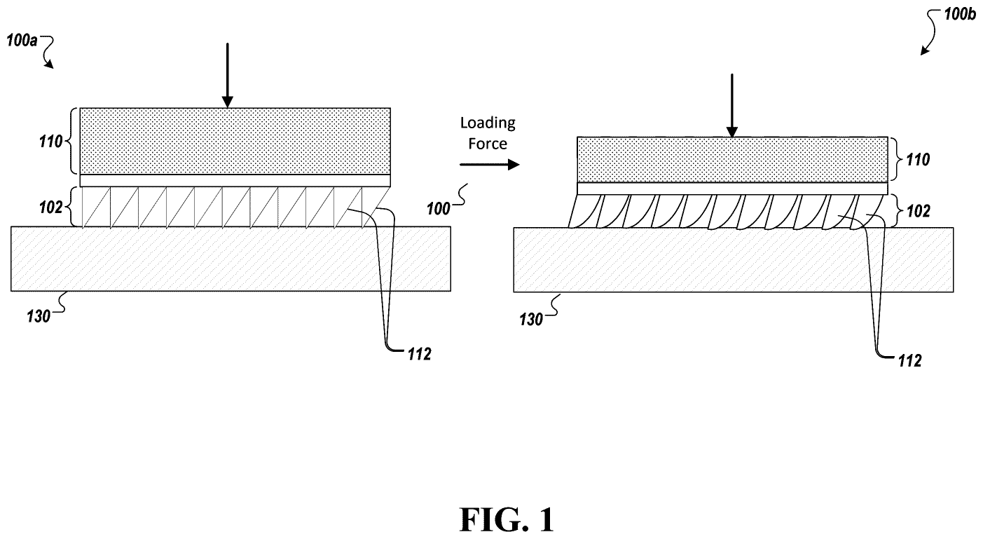

FIG. 1 illustrates an example of a dry adhesive material 100 (shown as 100a, 100b) according to one aspect of the present disclosure. The dry adhesive material 100 includes a gripping layer 110 comprising an adhesive surface 115 defining a plurality of shear-deformable adhesion micro- or nanostructures 112. The dry adhesive material 100 further includes a compliant backing layer 120 operatively coupled with the gripping layer 110 such that a loading force 130 applied normal to the compliant backing layer 120 causes the plurality of shear-deformable adhesion micro- or nanostructures 112 to electrostatically engage with a target surface 140.

The plurality of adhesion micro- or nanostructures are “shear-deformable” such that they are configured to elastomerically distort or deform as a result of a shear force. For example, when a loading force 130 is applied directly or indirectly to gripping layer 110 through the compliant backing layer 120, the plurality of shear-deformable adhesion micro- or nanostructures 112 can bend to increase the effective surface area of the adhesive surface 115 that contacts the target surface 140. In this regard, electrostatic forces, such as van der Waals forces, cause the gripping layer 110 to adhere to the target surface 140.

The term microstructure is used to refer to structures having at least one cross-sectional dimension that is from 1 micron to 1000 microns, such as from 100 microns to 1000 microns, or from 50 microns to 750 microns, from 50 microns to 500 microns, from 50 microns to 250 microns from 50 microns to 200 microns, or from 100 microns to 200 microns. Likewise, the term “nanostructure” refers to a structure having at least one cross-sectional dimension that is from 1 nm to 1000 nm, such as from 100 nm to 1000 nm, or from 50 nm to 750 nm, from 50 nm to 500 nm, from 50 nm to 250 nm from 50 nm to 200 nm, or from 100 nm to 200 nm. The plurality of micro- or nanostructures can have any of a wide variety of shapes, and can be formed of a wide variety of materials.

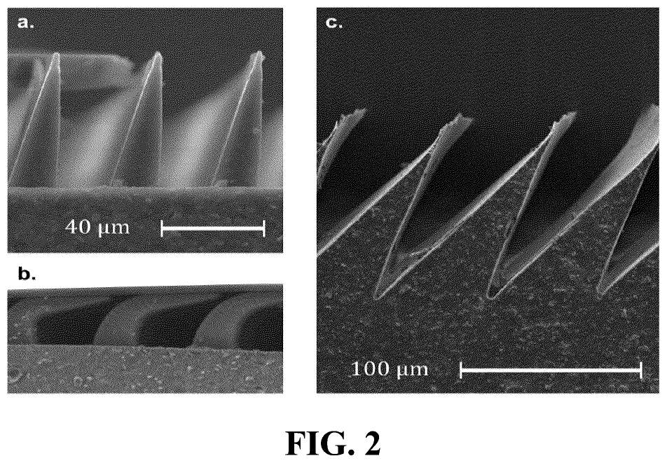

The various adhesion micro- or nanostructures can be formed in a number of different geometries. In some aspects, the adhesion micro- or nanostructures are directionally-biased, such as the directionally-biased micro-wedges shown in FIG. 2. Including a directionality to the noted micro- or nanostructures can impart anisotropic adhesive properties to the dry adhesive material. This anisotropic behavior can create a gripping direction and a releasing direction. For example, in the case of the directionally biased micro-wedges of FIG. 2, the offset configuration facilitates a gripping force when sheared away from the offset. The adhesion micro- or nanostructures can further be arranged in various patterns and surface densities along the adhesive surface to impart the requisite adhesive properties.

The dry adhesive material 100 further includes a compliant backing layer 120 operatively coupled with the gripping layer 110. Remarkably, it was demonstrated that the inclusion of a compliant backing layer in the dry adhesive material significantly enhanced shear performance when compared under similar conditions to dry adhesives without a compliant backing layer. In some aspects, the compliant backing layer has a thickness of 1 centimeter (cm) or more (e.g., 1.5 cm or more, 2 cm or more, 2.5 cm or more, 3 cm or more, 3.5 cm or more, 4 cm or more, 4.5 cm or more, or 5 cm or more). In some aspects, the compliant backing layer has a thickness of from 1 cm to 5 cm (e.g., from 2 cm to 5 cm, from 2 cm to 4 cm, or from 2 cm to 3 cm). In some aspects, the compliant backing layer comprises a material having a compressive stiffness of 1 MPa or less (e.g., 500 kPa or less, 400 kPa or less, 300 kPa or less, 200 kPa or less, 100 kPa or less, 50 kPa or less, or 25 kPa or less). As used herein, the terms, “compressive stiffness” and “compressive rigidity” are used interchangeably and refer to the ability of a material to resist deformation relative to a compressive load.

In some aspects, the compliant backing layer comprises a material having an average density of 100 kg/m3 or less (e.g., 75 kg/m3 or less, 50 kg/m3 or less, 40 kg/m3 or less, 30 kg/m3 or less, 20 kg/m3 or less, 10 kg/m3 or less).

In some aspects, the compliant backing layer includes a polymeric material. The polymeric material can, in some examples, include any natural or synthetic polymeric material. For example, the polymer material may be a homopolymer, heteropolymer, random copolymer, block copolymer, graft copolymer, mixture or blend of any suitable polymer(s), and it may be in any suitable physical form, such as a foam, film, woven or non-woven material, hydrogel, gel matrix, mixtures and blends thereof, and the like. In some aspects, the compliant backing layer comprises a porous foam material. For example, the compliant backing layer can include a polymer sponge.

In some aspects, the compliant backing layer comprises a material selected from the group consisting of elastomers and polymeric foams. The term “elastomer,” as used herein, refers to a material that changes properties in response to an applied force. Elastomers, in various formulations, can respond and/or react to normal forces, compression, torque, or sheer stresses or forces. Some example elastomeric material include, but are not limited to, silicone rubber, ethylene-propylene copolymer rubber, natural rubber, styrene-butadiene copolymer rubber, acrylonitrile-butadiene copolymer rubber, acrylic rubber, epichlorohydrin rubber, chlorosulfonated polyethylene, chlorinated polyethylene, urethane rubber and the like.

In some aspects, the polymeric foam comprises polyurethane foam, polyurea foam, polyolefin foam, polyester foam, polystyrene foam, polyether foam, or a copolymer thereof, or a combination thereof. In some aspects, the polymeric foam comprises an open cell foam. In some aspects, the polymeric foam comprises a closed-cell foam.

In some aspects, the compliant backing layer comprises a material having a Shore A hardness of 50 or less (e.g., 40 or less, 30 or less, 20 or less, or 10 or less). In some aspects, the compliant backing layer comprises a soft silicone rubber (e.g., silicon having a Shore hardness of 90A or less, 80A or less, 70A or less, 60A or less, 50A or less, 40A or less, 30A, or less, 20 or less, or 10 or less). In some aspects, the compliant backing layer has a Shore hardness ranging from 10A to 80A, 10A to 30A, 30A to 40A, 40A to 50A, 50A to 60A, 60A to 70A, 70A to 80, or with Shore hardness of 10A, 15A, 20A, 25A, 30A, 35A, 40A, 45A, 50A, 55A, 60A, 65A, 70A, 75A, 80A, 85A, or 90A.

In some aspects, the gripping layer comprises a flexible substrate disposed between the adhesive surface and the compliant backing layer. The flexible substrate can form a thin layer to increase resiliency of the plurality of adhesion micro- or nanostructures in the gripping layer. In some aspects, the flexible substrate has a thickness of 10 millimeters (mm) or less (e.g., 9 mm or less, 8 mm or less, 7 mm or less, 6 mm or less, 5 mm or less, 4 mm or less, 3 mm or less, 2 mm or less, 1 mm or less).

In some aspects, a peak shear force of the dry adhesive material is at least 1 N/cm² or more (e.g., 2 N/cm² or more, 3 N/cm² or more, 4 N/cm² or more, 5 N/cm² or more, 6 N/cm² or more, 7 N/cm² or more, 8 N/cm² or more, 9 N/cm² or more, 10 N/cm² or more, 15 N/cm² or more, 20 N/cm² or more, or 25 N/cm² or more) measured at a normal force of 1 N. In some aspects, a peak shear force of the dry adhesive material is at least 2 times greater (e.g., at least 2.5 times greater, at least 3 times greater) than a peak shear force of a dry adhesive material without a compliant backing. The term “peak shear force” as used herein refers to the maximum force in the shear direction before slippage occurs.

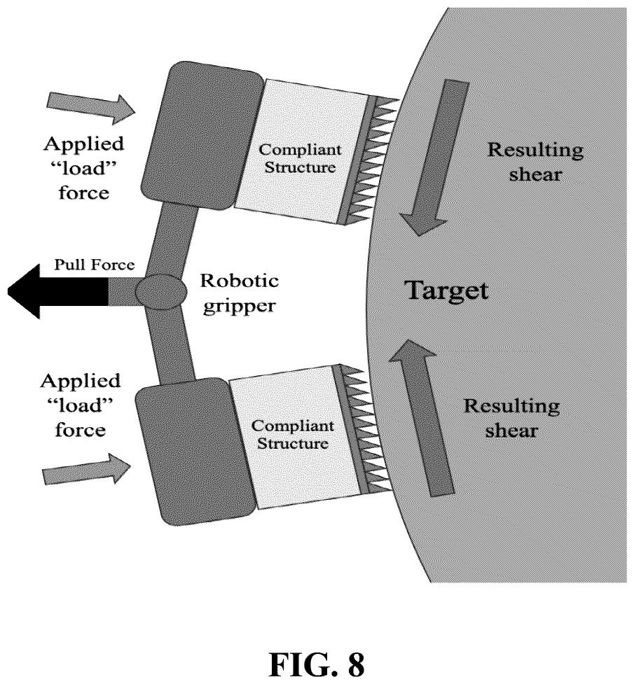

Also disclosed herein are end effectors comprising one or more moveable members, wherein at least a portion of an outer surface of the one or more moveable members comprises the any of the described dry adhesive materials. The present disclosure further provides robotic systems comprising the end effectors described herein. In some aspects, the robotic system includes a robotic arm comprising the end effector. In some aspects, the robotic arm is operatively coupled to a motor. In some aspects, the motor is configured to actuate the end effector to thereby impose a normal force on the dry adhesive. For example, FIG. 8 shows an exemplary use of the described dry adhesive materials on grippers of an end effector having enhance adhesive performance. For example, the presently described materials can be used as a robotic system, such as the one shown in U.S. Pat. No. 11,661,217, which is incorporated by reference in its entirety.

Also described herein are methods of gripping an object. In some aspects, the method includes: positioning the end effectors described herein proximate to an object; and actuating said end effector (e.g., via an applied normal force) to cause at least a portion of the dry adhesive material to contact the object to thereby secure (e.g., temporarily) the object to the end effector. As used herein, the term “proximate to” is a spatially relative term used to describe disposition of one object, to another object. The term “proximate” includes dispositions of indirectly adjacent to, directly adjacent to, and internal to. In some aspects, the method further includes moving the object from a first location to a second location. In some aspects, the method further includes disengaging said end effector to thereby release the object (e.g., at the second location). In some aspects, the object has a uniform surface area. In some aspects, the object has a non-uniform surface area.

Additionally described are textiles comprising the any of the dry adhesive materials described herein. The described material can be used to impart a passive adhesive functionality to a textile, for example, socks, gloves, anti-slip consumer products, and the like. Additionally described are articles comprising the any of the dry adhesive materials described herein. Exemplary articles include films, fasteners, building materials, and the like.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

The present example describes experiments used to study the effects of various compliant backing on peak shear force of dry adhesive materials.

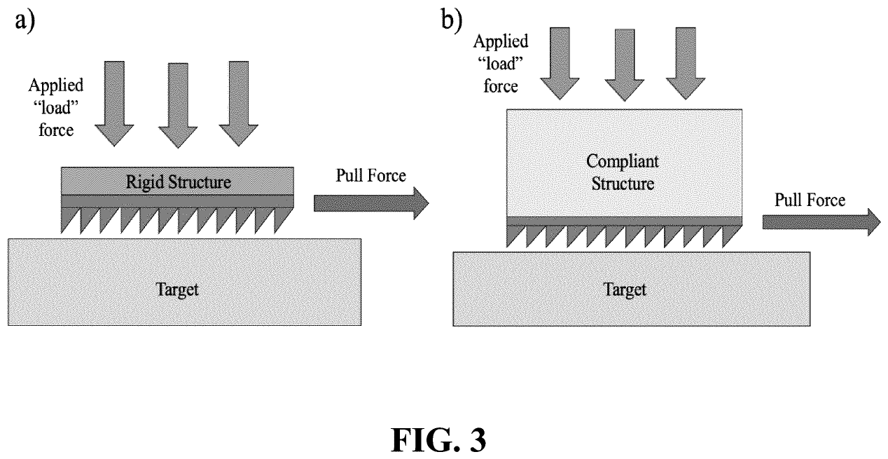

Briefly, a compliant backing structure is placed underneath the gecko tile (see FIG. 3). In the experiments, the gecko tile was “loaded” by applying a normal force into the tile via a tall box holding a specific loading weight (applied “load” force in FIG. 3). For purposes of this experiment, the bottom face of the box was the exact surface area of the gecko tile to ensure that the gecko tile was evenly loaded across its surface. A summary of the dimensions and material properties of the target, backing structures, and load box used across all experiments is presented below in Table 1.

TABLE 1
Summary of various experimental conditions.

| Item | Dimensions (cm) | Material |
|---|---|---|
| Flat Target | 5 × 5 × 0.3 | PLA Blend |
| Rigid Backing (flat) | 0.3 × 4 × 4 | PETG |
| Sponge Backing | 2.2 × 4 × 4 | Sponge |
| Silicone Backing | 1.42 × 4 × 4 | Silicone 10 |
| Flat Load Box | 4 × 4 × 8.15 | PLA |

Once the gecko tile was loaded, a pulling force was applied to it. This pulling force causes the gecko tile to be loaded in shear, which in turn causes the tile to adhere to the target surface. As the magnitude of the pulling force increases, the gecko tile grips the target until eventually the pulling force dominates over the gecko adhesive force, causing the gecko tile to slip from the target's surface. The magnitude of the pulling force value before the slippage was designated as the peak shear force, which directly translates to the tile's ability to adhere to a surface.

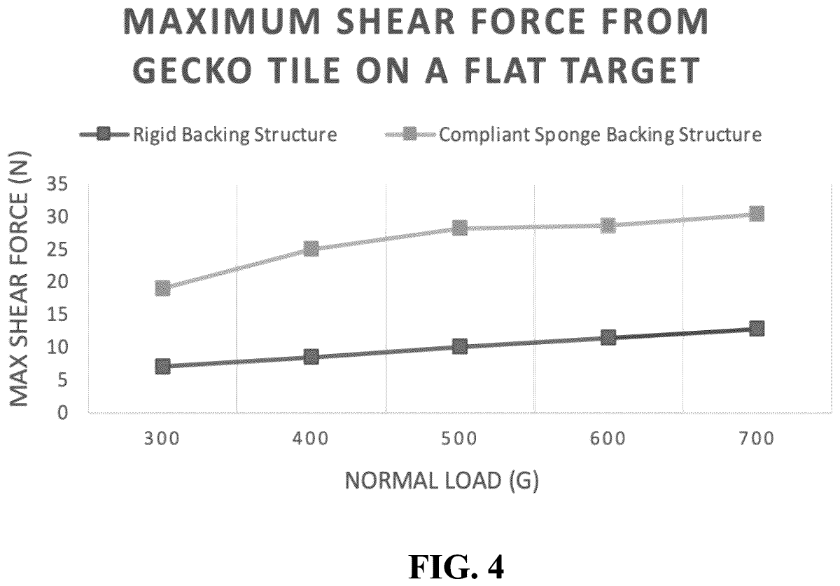

The difference in peak shear force output from similar configurations of gecko tile after the addition of a compliant backing structure instead of a rigid backing structure is shown in FIG. 4. Interestingly, the measured peak shear force was consistently 2-3 times higher after the introduction of the compliant structure to the tile. Thus, the adhesive properties of the gecko tile are greatly enhanced by the introduction of a compliant backing structure.

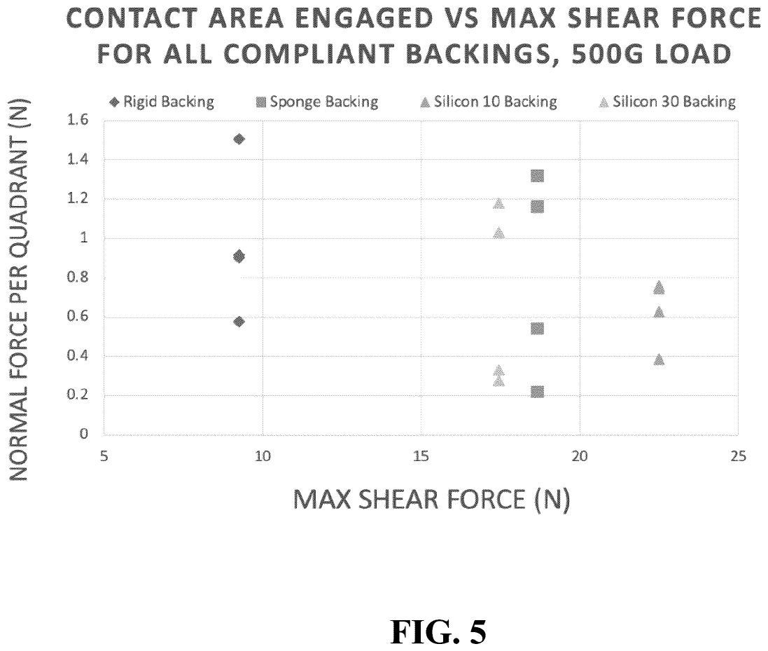

A sponge was used as the compliant backing structure in FIG. 4. To further explore this insight, other compliant structures, namely, silicon prisms with different shore hardness values, were also studied. The experimental setup utilized the same pull tests for these additional compliant backing structures as described above. A plot showing the results of these experiments can be seen in FIG. 5, whereby the peak shear force before slippage is plotted against the normal force delivered to the target. The normal force delivered was measured using four force sensors in a two-by-two matrix underneath the gecko tile. Therefore, for each peak shear force reading per compliant backing structure, there were four normal force values associated with that structure. As can be seen in FIG. 5, the three compliant backing structures (sponge, silicon with Shore hardness of 10, and silicon with Shore hardness of 30) produce much greater peak shear before slippage than any rigid backing structure (blue data in FIG. 5).

Therefore, the addition of any of these compliant backing structures result in more than twice the amount of peak shear to be gained out of the same gecko tile. This means the gecko tile is able to adhere to a target significantly better than if it were mounted on a rigid backing structure.

### Discussion

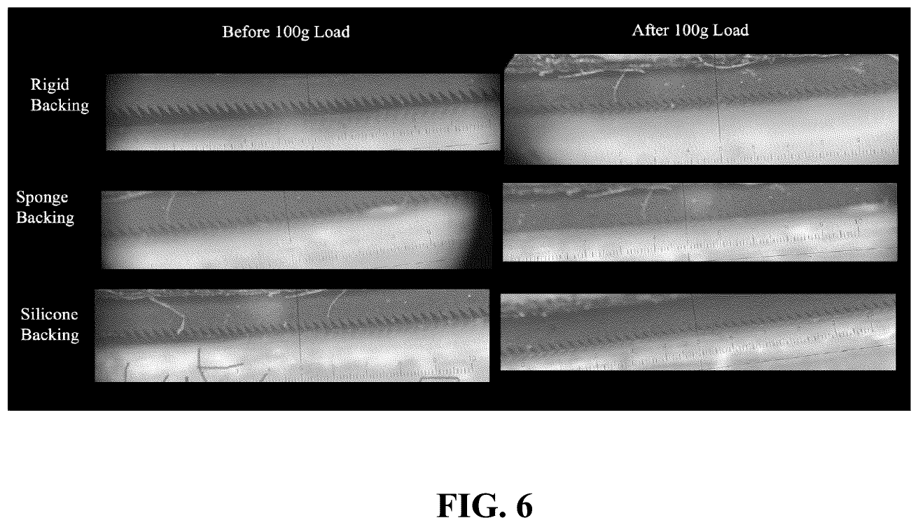

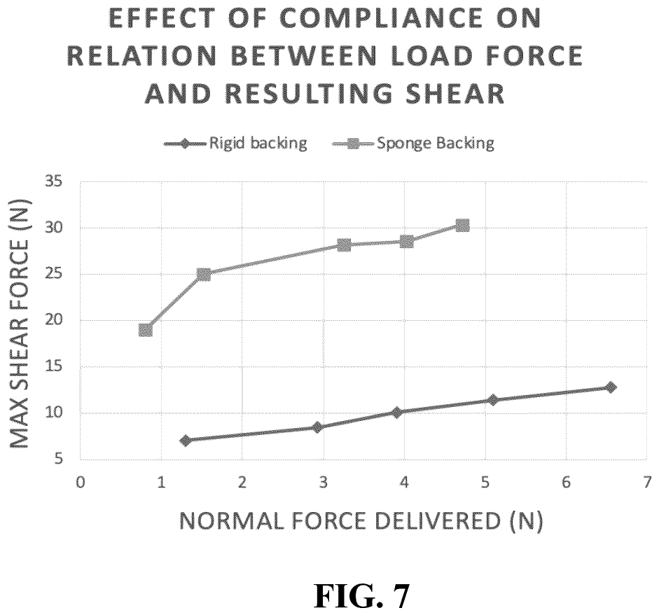

As a load is applied to a gecko adhesive, additional surface area of the gecko adhesive comes into contact with the target surface. To attempt to better understand the physical mechanism behind the improved shear performance of the gecko adhesive when used with a compliant backing structure, side-views of gecko adhesives were collected under a microscope for different backing structures and a 100 g load. As depicted in FIG. 6, the gecko adhesive (top of each image) was somewhat reflected upon contact with the target (bottom). One can notice how the micro-structures bend such that more of the adhesive comes into contact with the target as load is increased across all backing structures. A comparison of the sponge backing structure to the rigid structure under the same load illustrates that the compliant structure can exhibit comparable or better pre-loading of the gecko tile. (FIG. 7). In this regard, the microwedges are more deflected—and therefore have more contact surface area with the target—for the same load, thereby resulting in a substantial increase in the peak shear force.

### Example 2

Additional experiments were conducted to explore the influence of contact area and distributed load on the adhesive properties of gecko tile.

### Targets and Gecko Tile Backing Structures

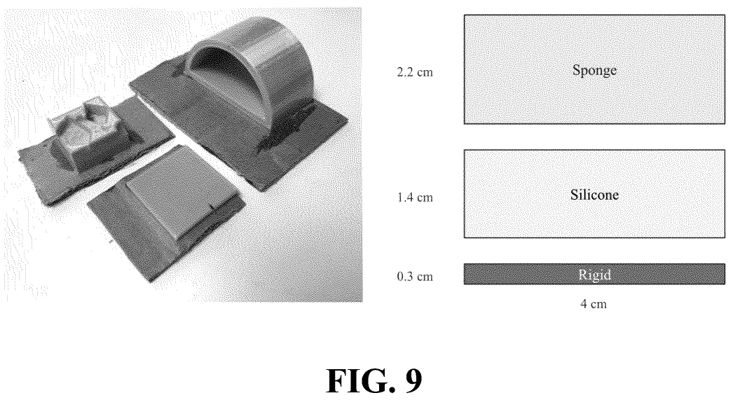

The compliance of a gecko tile was tested to objects of different geometries. In order to test on geometrically diverse targets while maintaining consistency in material and surface smoothness, three surfaces were 3-D printed to act as target objects in this experiment (see the left-hand side of FIG. 9). After printing, each object was glossed with XTC-3D High Performance 3D Print Coating to ensure a consistent, smooth surface for the gecko tile to adhere to in subsequent experiments.

To mimic implementation onto a mechanical system, backing structures were chosen to adhere the gecko tile to. For this experiment, three different backing structures were selected: one 3-D printed rigid structure, one backing made of a thick layer of sponge, and one backing made of a thick layer of silicone with a shore hardness of 10 (see right-hand side of FIG. 9). For implementation onto the curved surface, a curved version of the rigid backing structure was printed which matches the surface curvature. The study then tested each of these three backing structures on each of the three surfaces to determine which backing structure most evenly distributes load while maximizing surface area of contact between the gecko tile and the surface.

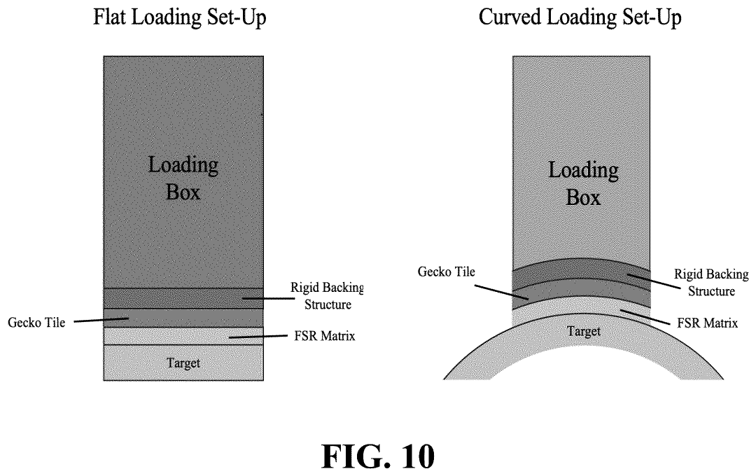

Finally, two loading containers were printed to apply an even load to the gecko tile as it contact the surface. The loading boxes were filled with lead-shot to ensure an even distribution of load across the gecko tile's surface. One load box has a square 4×4 cm bottom which matches the gecko tile's surface area, and is used to load the gecko tile on the flat and irregular surfaces. The second loading container is made to load the entire surface area of the gecko tile on the curved surface, and therefore as a curved bottom (see FIG. 10).

A summary table containing information about the backing structures, targets, and loading containers is provided in Table 2.

TABLE 2
Dimensions and materials of all backing structures, 3D-printed
surfaces, and loading boxes used in this experiment.

| Item | Dimensions (cm) | Material |
|---|---|---|
| Cylindrical Target | d = 9.5, h = 5, width = 0.61 | PLA Blend |
| Flat Target | 5 × 5 × 0.3 | PLA Blend |
| Irregular Target | 4 × 4 × 2, max depth = 1 | PLA Blend |
| Rigid Backing (flat) | 0.3 × 4 × 4 | PETG |
| Rigid Backing (curved) | d = 4, h = 4, width = 0.41 | PETG |
| Sponge Backing | 2.2 × 4 × 4 | Sponge |
| Silicone Backing | 1.42 × 4 × 4 | Silicone 10 |
| Flat Load Box | 4 × 4 × 8.15 | PLA |
| Curved Load Box | 4 × 4 × 9.5 | PLA |

Experimental Procedure. Once setting up the system for data-taking, the code described above is used in the Arduino IDE to read out force values for each sensor over time. A value is read out for each sensor every 0.1 seconds. In order to account for fluctuations in the sensor readings, the study determined when the readings stop fluctuating by more than 0.1 over 20 time-steps. This allows time for the load box to settle onto the target, especially for the non-rigid backing structures. Once this is true for all sensors, the data is processed in the next 150 time-steps. Then, the most common value present in that set of 150 data points for each sensor are taken, and set this to the force value reading for that sensor. This was done for each sensor. Finally, three separate trials are done for each backing structure and surface combination. After averaging the final force reading over the three trials, a force value reading per sensor is outputted for that backing structure and surface combination.

### Results

Quantifying Tile Contact Engagement Per Backing Structure. In this section normal force data for each quadrant of the force sensor matrix are presented as backing structures and surfaces are changed. The maximum quadrant engagement was regarded as an indicator of maximum surface area of contact. Next, the study looked at total normal force delivered to each surface for each backing structure.

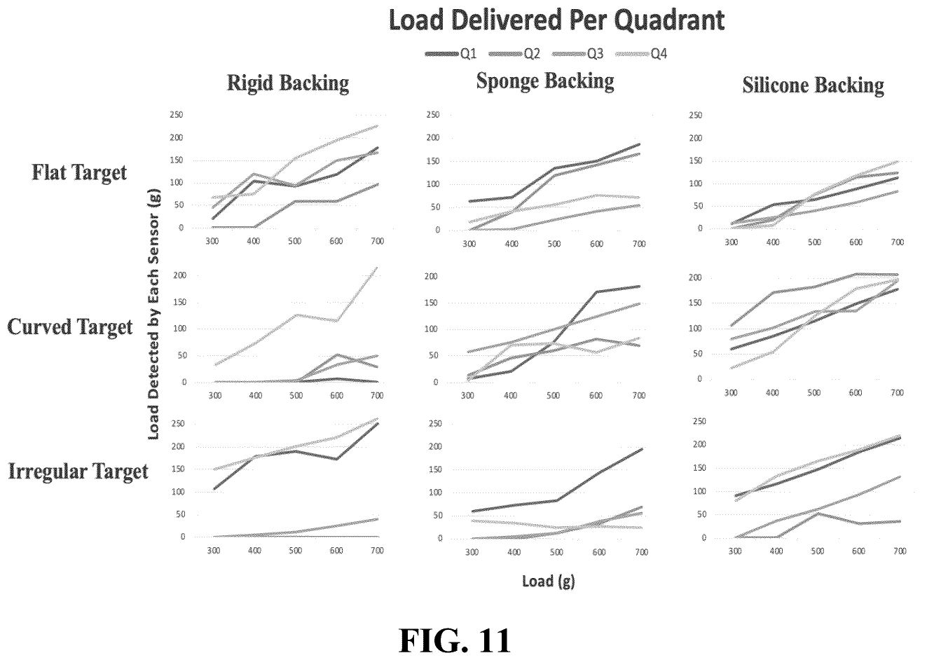

Normal force delivered to the surface for all permutations of surfaces and backing structures is presented in FIG. 11. Each line represents a quadrant of the FSR matrix shown in FIG. 9, and are labeled as Q1 (quadrant 1), Q2, etc.

For all experiments, force delivered per quadrant increases as a function of load. Looking at the first column (rigid backing structure data), one can see that three quadrants are engaged for the lightest load on the flat surface. Similarly, for the curved and irregular surfaces it was seen that even fewer quadrants are engaged. For the curved surface, quadrants 2 and 3 become engaged as load increases. Without wishing to be bound by theory, this effect could be due to curvature inconsistencies between the curved, 3D-printed structures used for this loading set-up (see the left-hand side of FIG. 10). If their radii of curvature do not match perfectly, the surface areas of contact between them will be affected. However, it was noticed that as compliant structures are implemented on the curved surface (looking across columns 2 and 3 in FIG. 11), more consistent quadrant engagement is shown.

For the irregular surface, Q2 and Q3 are virtually never engaged by the rigid backing structure due to the geometry of the surface (see the left-hand side of FIG. 9). However, the introduction of the silicone backing structure helps to engage more quadrants for the irregular surface. Looking at the figure in the last row and last column of FIG. 11, it can be seen that Q2 and Q3 are picked up through the use of the silicone backing structure. This indicates that the use of silicone backing structure causes an unexpected increase in surface area of contact and more total normal force delivered to the irregular surface.

Looking at the first row of FIG. 11, it can be seen that the lines for quadrant data begin to overlap more moving from left (rigid) to right (sponge and silicone structures) for the flat and curved surfaces. Without wishing to be bound by theory, this could be reflective of more equal loading sharing across the gecko adhesive as compliant structures are implemented.

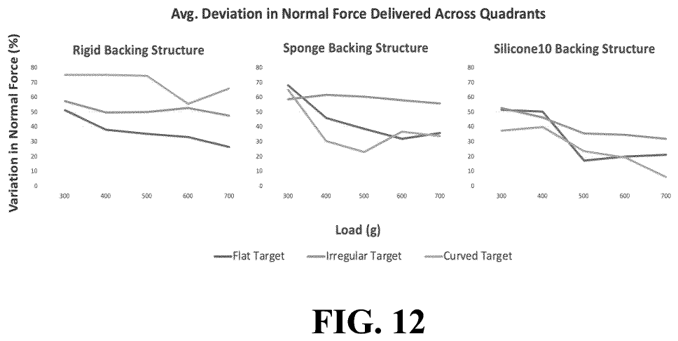

Quantifying Backing Structure Load Sharing Performance Across All Targets. Next, the study analyzed how well the load is distributed across the gecko adhesive by each backing structure. To do so, the study first identified the maximum normal force value per quadrant for each load. In order to normalize the data for comparison across structures, each force reading per quadrant was taken and divided by the maximum force reading for that load. This gives a fraction of the maximum normal force value per load for each backing structure. Then, the study found how much each force reading varies from the maximum normal force. The study then presents this number as a percent of variation from the maximum normal force for each quadrant of the force sensor matrix. Finally, after calculating percent of variation of each quadrant, the values are averaged over all quadrants to get the average percent variation from the maximum normal force reading for that backing structure as a function of load. Results are plotted in FIG. 12.

It is noted that the least amount of percentage of variation from maximum normal force delivered is optimal because this implies the most equal load sharing on the gecko adhesives. Overall, it was seen that the rigid backing structure is most consistent in its load sharing as load increases for the irregular and flat surfaces. However, variation is seen in force on curved surface is inconsistent as load increases. Again, without wishing to be bound by theory, this could be due to imperfect matching, due to small printing error tolerances, between the curvature of the rigid backing structure and the cylindrical target's surface (see FIG. 10).

For large loads (>400 g), the silicone backing structure may be the best option for equal load sharing, as there is a notable decrease in its percent variation at greater than 400 g, especially on a flat surface. This could be due to the even compression of the silicone as load increases. To summarize, load sharing performance is most consistent for the rigid backing structure for the non-curved surfaces. However, at loads >400 g, the silicone backing structure may be better than the rigid backing structure at load sharing as it can compress more evenly.

In this section, the study examined how the adhesive power of a gecko tile can change based on its implementation. Specifically, the study looked at gecko adhesive strength for rigid and compliant (sponge) backing structures across the different surfaces introduced in the previous chapter. Additionally, the study looked to relate the normal force delivered to a surface from an applied load (data from the previous chapter) to the maximum adhesion obtainable from a gecko adhesive. Doing so could begin to allow for a prediction of the shear adhesion one could get out of a gecko tile based on the force applied to it, the target surface, and the backing structure employed.

### Experimental Set-Up

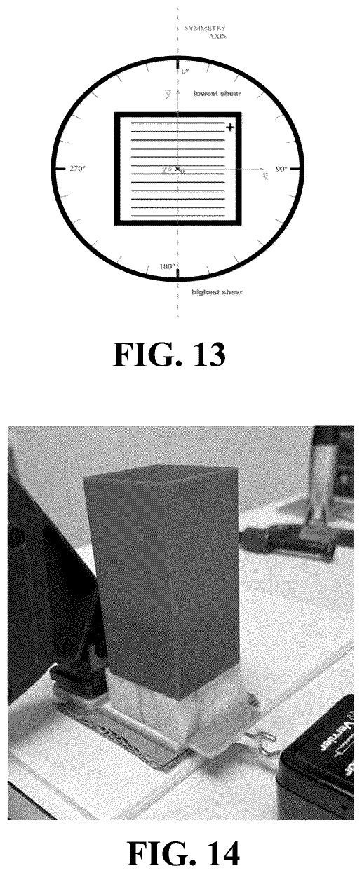

The set-up for these experiments is very similar to the loading set-up presented in above (see FIG. 10). However, a few changes were made to this experimental set-up. First, the gecko tile was outfitted for pull tests in the optimal direction of pull (180-degrees in FIG. 13) using layers of tape and fabric (see FIG. 14). The gecko tile was also fully attached to each backing structure. To attach the tile, the study used double-sided Guerilla Duct Tape cut to the size of the gecko tile (4×4 cm). Finally, each 3D-printed surface was mounted on a stiff cardboard base which is then clamped to the tabletop as the gecko adhesive is pulled and activated in shear. This stabilizes the surface as the tile is pulled and sticks to it (FIG. 14).

The study sought to test the adhesive strength of the gecko tile as backing structure and target surfaces are varied. A Vernier force sensor was attached to the gecko tile as in FIG. 14. The tests were conducted to ensure that the pull vector is in-plane with the gecko tile since changes in adhesives strength could occur if not pulling within this plane. Sheets of paper were used to level the pull from the force sensor with the plane of the tile (see FIG. 14). It is important to note that for the curved target, pulling in the plane of the gecko tile means pulling tangent to the curved target's surface where the gecko tile is adhered.

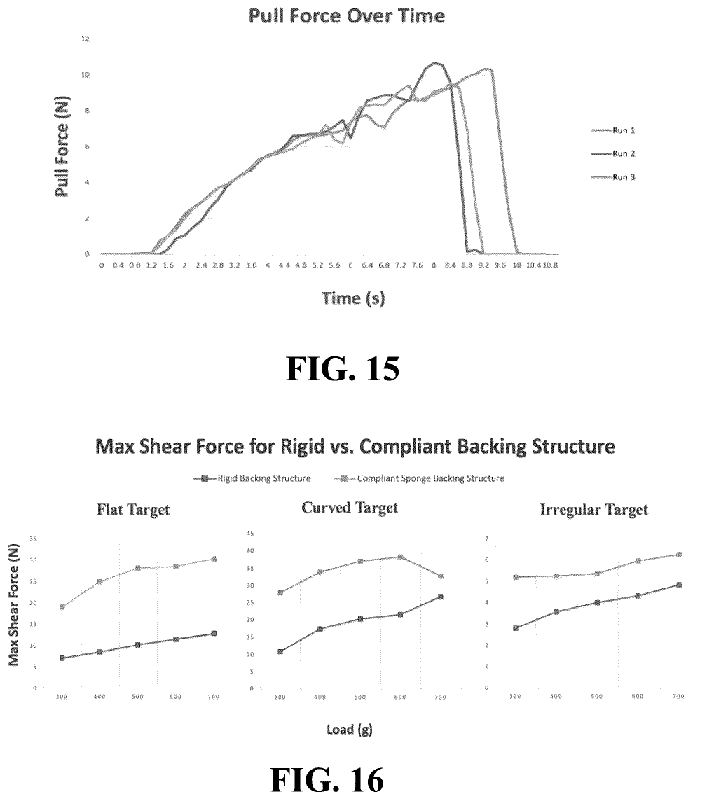

Next the pull force was plotted as a function of time, applying more force until the gecko adhesive slips from the surface. Then, the maximum force value is recorded as F_{s,max}: the maximum shear (adhesive) force that the gecko tile is able to produce before slipping. See FIG. 15.

The load applied to the gecko adhesive was varied as described above, which allows for a clearer picture of how maximum adhesion can change with applied normal force. The gecko tile were loaded as evenly as possible through the use of lead-shot pellets evenly distributed inside the load container. For each data point three pull tests were completed, as shown in FIG. 15. There was a drastic drop-off in pull force (shear force) readings at one point during each run. This drop-off corresponds to when the gecko tile slips from the target surface. The location of this drop-off varies from trial to trial due to human inconsistencies in impulse application. The maximum pull force value reached before slippage is noted for each run. After three runs, the average maximum shear force value is stored as F_{s,max} for that backing structure and surface.

### Results

Maximum Adhesion for Compliant vs. Rigid Backing Structures. The maximum shear value a gecko tile can produce for rigid and compliant (sponge) backing structures is presented in FIG. 16. It can be seen that maximum adhesive strength increases with applied load across all targets—with the exception of only one data point. Although the nature of this research necessitated this, gecko adhesives are not meant to be pulled to failure many times, as this can degrade and break the micro-wedges, resulting in less adhesion over time. The data for the curved target at 700 g was taken last. It can be seen that the real-time degradation of this gecko tile as it begins to produce less maximum shear values after all other data points have been gathered.

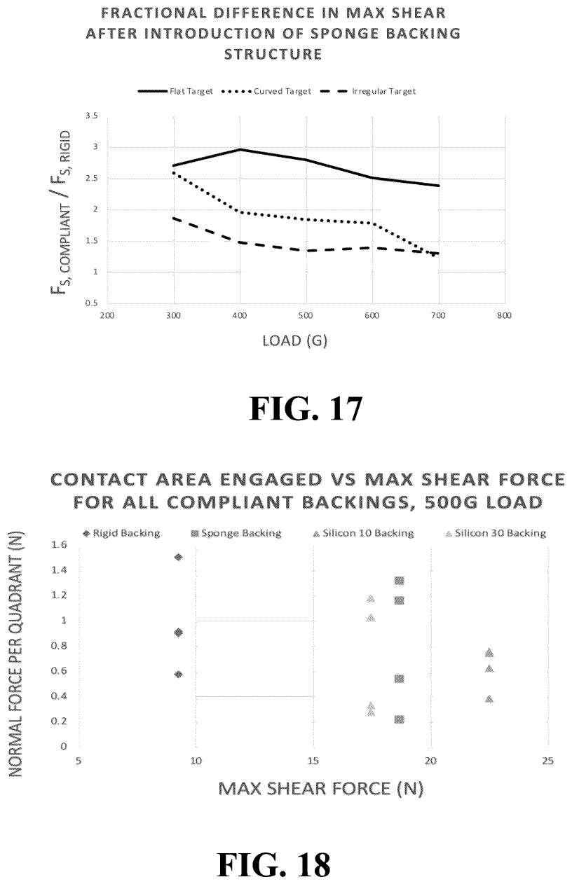

Remarkably, it can be seen that across all surface geometries, the compliant backing structure out-performs the rigid backing structure in producing maximum adhesion from the gecko tile. To quantify this difference in maximum shear adhesion, FIG. 17 was plotted. In this figure, the gains in shear were computed across all targets by taking F_{s,max} for the compliant backing structures (F_{s,compliant}) over the F_{s,max} for the rigid backing structures F_{s,rigid}. Doing so reveals a remarkable 2.5-3× increase in maximum shear adhesion on the flat surface with the introduction of a compliant backing structure. Similarly, there is a 1.3-2× increase in maximum shear adhesion on the curved and irregular surfaces, with the irregular surface showing the least increase in maximum shear. As applied load increases, gains in shear from the introduction of a compliant backing structure tend to decrease across all surfaces. It was noticed that the maximum shear values obtained are quite different across surface geometries, but a consistent increase was seen in adhesive performance across all surfaces.

The shear adhesion of a gecko tile was plotted as different compliant structures are varied and compare this to the rigid backing structure in FIG. 18. Specifically, data was presented for the sponge backing, the silicone10 backing (a silicone prism with a shore hardness of 10, with dimensions described above), and a similar silicone30 backing (with a shore hardness of 30). It was unexpectedly seen that all tested compliant backing structure options outperform the rigid backing structure option in FIG. 18.

Without wishing to be bound by theory, it is believed that this increase in adhesion results from a macroscopic increase in surface area of contact. When placing a gecko adhesive onto a rigid backing structure and trying to adhere to another flat surface, there are bound to be small errors or warps in the two surfaces such that neither “flat” surface is actually “flat”. These warps can come about through the 3D-printing process (if the surfaces are printed) or simply through gradual wear and tear of a surface. These irregularities mean that there will almost never be direct plane-on-plane contact between two surfaces. This results in a decrease in maximum adhesive strength for a gecko tile mounted on a rigid backing structure.

Using a compliant backing structure leaves room for these surface irregularities, and allows the gecko tile to conform to the surface it contacts. Therefore, more of the gecko tile makes contact with the surface each time, causing an increase in adhesive strength of the gecko tile. To view the microscopic effect, several images were taken of the bending of a gecko adhesive under a 100 g load for different backing structures (note: no pulling force is being applied on the gecko tile in these experiments: only a loading force is applied to the tile with 100 g).

After loading the rigid backing structure, it can be seen that a lot of the micro-wedges are still not properly engaged (i.e., they are not touching the surface and starting to deflect from normal position). However, it can be seen that there could be improvements for the two compliant structures, as these images could show better engagement of the micro-wedges compared to the rigid backing structure after loading.

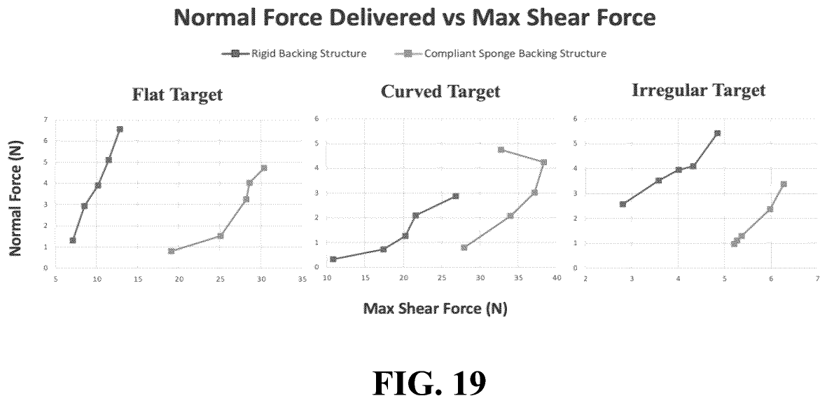

Relating Applied Force and Maximum Adhesion. To add to the analysis and further characterize how maximum adhesion varies with normal applied load, normal force delivered to the gecko tile were plotted against the resulting maximum shear in FIG. 19. The normal force data for each backing structure and surface combination was gathered as described above.

In FIG. 19, it can be seen that as normal force on the gecko tile increases, the maximum shear force increases as well (with the exception of the last compliant data point for the curved target, for reasons discussed in the previously). It can also be seen that across all surfaces, the curves corresponding to the rigid backing structure peak at lower max shear force values than the curves corresponding to the compliant backing structure for the same normal load. Without wishing to be bound by theory, this implies that the same load on a gecko tile achieves greater maximum shear force values when using a compliant backing structure instead of a rigid one.

To summarize, it has been shown here that for the same applied load on a gecko tile, one is able to increase the maximum shear performance of a gecko tile by using a compliant gecko backing structure. This increase in maximum shear adhesion can translate to better adhesive performance of that tile on a mechanical gripper.

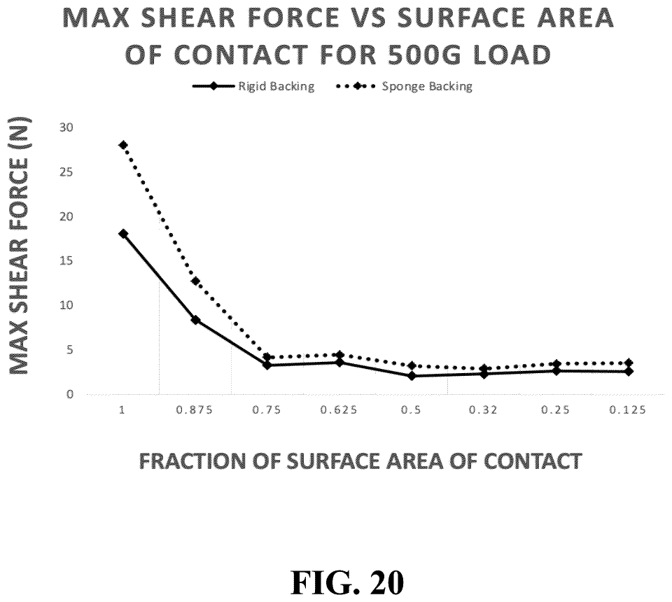

In FIG. 20, the maximum shear force a gecko tile is able to produce before slipping was plotted against the gecko tile's surface area of contact with a surface. Remarkably, it can be seen that as the surface area of contact between the gecko tile and the target surface decreases, there is a drastic and immediate reduction in the maximum shear force that gecko tile is able to produce before slippage. It was shown that a reduction to 46.49% of possible shear force at a contact surface area of 87.5% of full contact for the rigid backing structure. At 75% surface area of contact, it was shown to have already decreased in adhesion to 18.24% of the maximum possible shear force value.

For the sponge backing structure, similar behavior can be observed: at 87.5% of surface area of contact, 45.48% of maximum shear remained. At 75% contact area, 14.87% of the shear corresponding to full surface area of contact remained.

In summary, the surface area of contact between a gecko tile and a surface has a substantial impact on the shear performance of that gecko tile. Compliant backing structures offer a potential solution to preserving initial contact area (especially with irregular geometries). There is a small but consistent difference in shear performance between objects with uniformly-removed surface area (mimicking a porous surface) and non-uniformly removed surface area of contact (mimicking non-ideal contact with a flat surface). This implies that gecko adhesives have worse adhesion to more porous surfaces compared to smooth surfaces with the same overall contact area.

The findings in this section have implications for the application of gecko adhesives onto mechanical gripper systems. Of all variables studied so far, the area of contact between a gecko tile and a surface is the biggest indicator of adhesive performance of the gecko tile. Therefore, gecko grippers should prioritize maximizing surface area of contact with an object when implementing gecko adhesion on a mechanical gripper.

### Angle of Applied Load

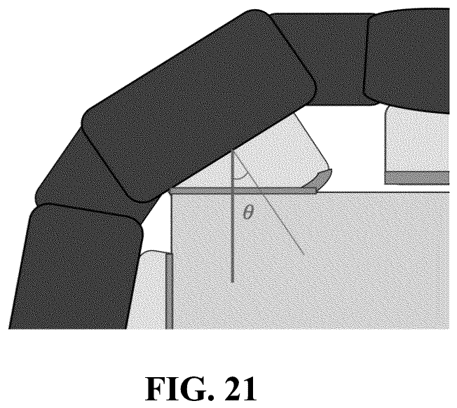

When implementing this backing structure on a mechanical system, off-nominal loading can occur when the mechanical gecko gripper closes onto an irregularly-shaped object (see FIG. 21). Off-nominal loading was defined as any force applied to a gecko tile which is not normal to the gecko tile's surface. The study sought to better characterize off-nominal loading of gecko tiles to expand the analysis of gecko adhesion and its effectiveness in capturing geometrically-diverse objects when compliant gecko backing structures are used.

This section sought to quantify the load distribution onto the gecko tile as angle of load is varied and to relate this to the shear performance of the gecko tile based on previous experimentally-derived metrics.

### Application to a Gecko Gripper

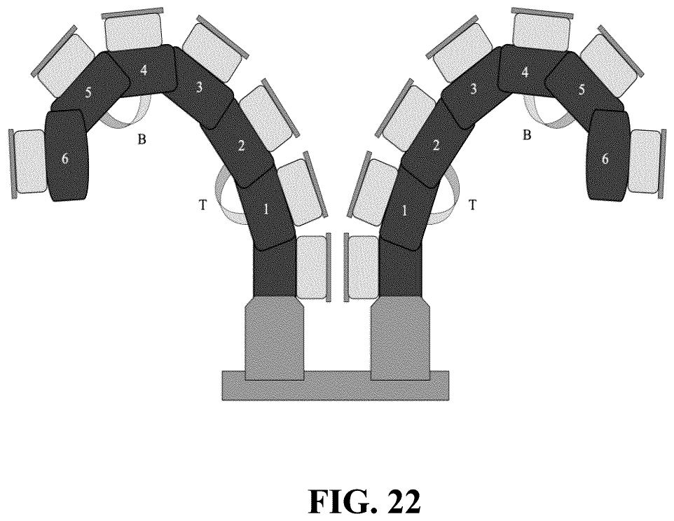

At the USC Space Engineering Research Center (SERC) a robotic system with applications meant to address ADR and In-Space Servicing, Assembly and Manufacturing (ISAM) was developed in 2019 [35]. The device, called REACCH, is a biologically inspired end-effector with motor-actuated limbs which deploy to grasp objects [36]. In this set of experiments, the REACCH design was used as a sample gripper system on which to test different strategies at increasing compliance of a robotic gecko gripper to geometrically diverse surfaces [37]. A depiction of the REACCH gripper is shown in FIG. 22. Each arm contains seven gecko tiles which can come into contact with a surface. As the gecko tiles contact the surface, a shear force is instantiated between REACCH and the target, allowing REACCH to adhere to the object.

System-Level and Tile-Level Compliance. Since surface area of contact has proven to be the most substantial predictor of shear adhesion, the study wanted to maximize contact area of the gecko tiles with any surface to ensure optimal adhesion; labeled as “tile-level” compliance: the amount of contact between a gecko tile and the surface which REACCH attempts to grab. More compliance on the gecko-tile level means more surface area of contact. This is the first level of compliance in the robotic gripper system that was investigated.

Additionally, the study investigated increasing REACCH's knowledge of the surface it grabs. To do this, REACCH was outfitted with pressure sensors and flexion sensors which give clues into the status of the grab sequence and the success of the grab attempt (see FIG. 21 for sensor placement on the REACCH arms). A flexion-sensor and pressure-sensor feedback control algorithm were created, which are labeled as the “system-level” compliance strategy. This compliant grab sequence was compared, which has feedback about a target, to a non-compliant grab strategy called “manual” grab. The study defined the “manual” grab sequence as controlled by an operator based on only visual input (i.e., the operator tells REACCH to keep grabbing until it appears it has made good contact with the target surface). Therefore, system-level compliance was examined by comparing these two control methods.

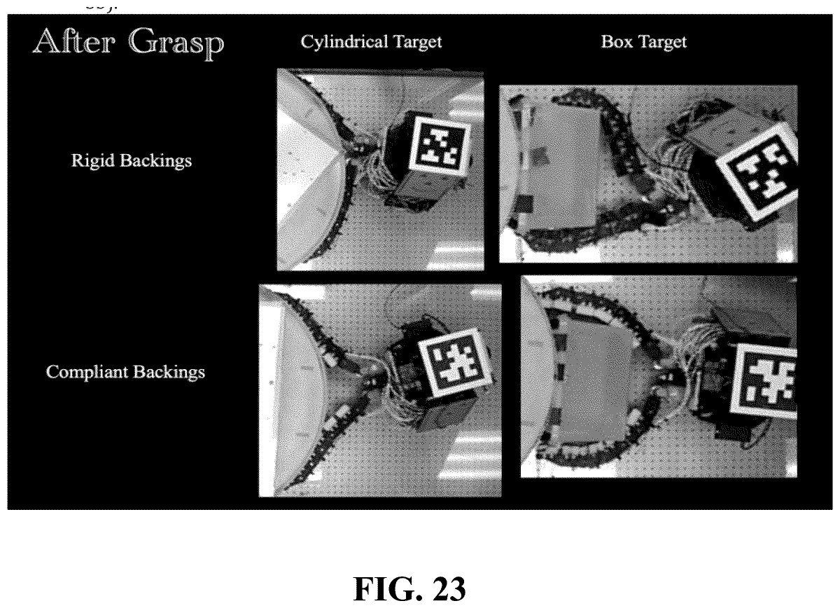

Experimental Set-Up and Infrastructure. These experiments make use of the USC SERC Air-Bearing Platform (ABP) [38]. During each experiment, both REACCH and the target to be grabbed are “floating” on the quasi-frictionless 3-DOF ABP with the help of “floatbots” [38]. Three grab attempts were completed for each of 8 different experimental set-ups. Each experimental set-up corresponds to a unique combination of compliance strategies (tile and system-level) against two target objects: a smooth, 0.8 m cylindrical object, and a smooth plastic box of dimensions 9×8×13 in (see FIG. 23).

During each grab attempt, REACCH was placed very close to the target with its two limbs partially curled back. Then, REACCH was actuated with one of the two aforementioned control strategies until a grab is achieved. Since both the target and REACCH are floating, this can result in some small two-body dynamics. The number of force sensors activated during each grab attempt was recorded, and report the average of three total activated sensor values for each experimental set-up. A force-sensor readings could be reported because the gripper is providing a mechanical force into the object as well as a shear force with its gecko adhesives. The study used these force sensor readings as the indicator of contact between the gecko adhesives and the target surface. Three variables are being compared across the 8 experimental set-ups:
Rigid Gecko Tile Backings vs. Compliant Foam Tile Backings: The study switched out tile backing structures to investigate the effect of tile-level compliance. Both backing structures have the same height to control for contact distance from the REACCH links.
Manual vs. Sensor-Feedback Control Strategies: The study used two different actuation strategies to investigate the effect of system-level compliance in a control algorithm.
Cylindrical vs. Box Target: The study tested these two compliance introduction strategies against two different objects to see which compliance strategies may work best across both objects.

### Results

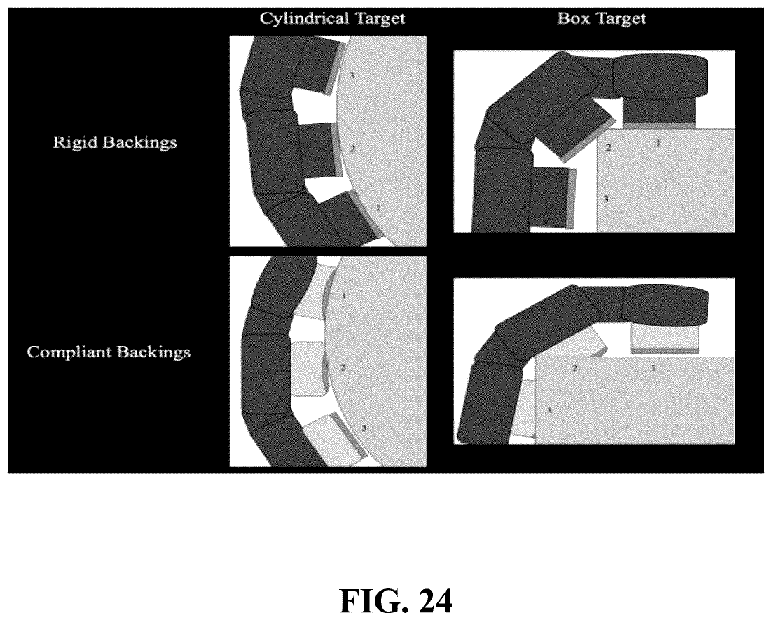

When grabbing the box with the compliant backing structures, the REACCH limbs are able to conform to the object's surface, making contact around the box's corners. This is less likely to happen when using the rigid backing structures, as these can become stuck on the corners and other links can be pushed away from the box's surface. An illustration showing engagement behavior of the rigid and compliant backing structures when applied to the cylindrical and box targets is shown in FIG. 24.

In summary, it was shown that the compliant gecko tile backing structures result in greater gecko tile engagement than rigid backing structures on the box object. This implies that compliant backing structures provide better adhesion for applications when a gecko gripper needs to grab a geometrically irregular object.

Additional experimental results and discussion are described in Statton, M. (2024). Optimizing Element & System Compliance of Robotic, Gecko Adhesion-Based Grippers to Unprepared Space Debris Targets, which is expressly incorporated by reference in its entirety.

The systems, methods, and devices of the appended claims are not limited in scope by the specific systems, methods, and devices described herein, which are intended as illustrations of a few aspects of the claims and any systems, methods, and devices that are functionally equivalent are intended to fall within the scope of the claims. Various modifications of the systems, methods, and devices in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. All references cited and discussed in this specification are incorporated herein by reference in their entirety and to the same extent as if each reference was individually incorporated by reference. The following patents, applications, and publications as listed below and throughout this document are hereby incorporated by reference in their entirety herein.

### REFERENCES

[1] Bongers, A., & Torres, J. L. (2024 May 6). Low-Earth orbit faces a spiraling debris threat. Scientific American.
[2] Gorman, D. (2024 July 24). ESA report shows unsustainable levels of orbital debris. Payload.
[3] The growth of all tracked objects in space over time (space debris and satellites).png-Wikimedia Commons. (2022 April 21).
[4] Time to clean up low Earth orbit. (2022). Nature Astronomy, 6 (10), 1099-1100.
[5] COSMIC-Astroscale, Securing Space Sustainability. (2024 April 22). Astroscale.
[6] REACCH-KMI. (n.d.). Kall Morris Incorporated.
[7] REACCH (Reactive Electro-Adhesion Capture CLOTH)—Space Engineering Research Center. (n.d.).
[8] Active Debris Removal—KMI. (n.d.). Kall Morris Incorporated.
[9] Shouse, B. (2002 August 27). How Geckos Stick on der Waals: Revealing the lizards' secret, engineers aim to make wall-walking robots. Science.org. Retrieved Nov. 12, 2024.
[10] Libretexts. (2023 January 30). Van der Waals Forces. Chemistry LibreTexts.
[11] Day, P., Eason, E. V., Esparza, N., Christensen, D., & Cutkosky, M. (2013). Microwedge machining for the manufacture of directional dry adhesives. Journal of Micro- and Nano-Manufacturing, 1(1).
[12] Applications-Ultra Strong Dry Adhesive for Space, Manufacturing, Robotics and more-geCKo Materials. (n.d.). geCKo Materials.
[13] Parness, A. (2017). Testing Gecko-Like adhesives aboard the International Space Station. AIAA SPACE and Astronautics Forum and Exposition.
[14] E. W. Hawkes, E. V. Eason, A. T. Asbeck and M. R. Cutkosky, “The Gecko's Toe: Scaling Directional Adhesives for Climbing Applications,” in IEEE/ASME Transactions on Mechatronics, vol. 18, no. 2, pp. 518-526, April 2013, doi: 10.1109/TMECH.2012.2209672.
[15] Hawkes, E. W., Eason, E. V., Christensen, D. L., & Cutkosky, M. R. (2014). Human climbing with efficiently scaled gecko-inspired dry adhesives. Journal of the Royal Society Interface, 12(102), 20140675.
[16] Stanford engineers climb walls using gecko-inspired climbing device. (2015 January 6). Welcome to Bio-X.
[17] Purtov, J., Frensemeier, M., & Kroner, E. (2015). Switchable adhesion in vacuum using Bio-Inspired dry adhesives. ACS Applied Materials & Interfaces, 7(43), 24127-24135.
[18] Henrey, M., T′ellez, J. P. D., Wormnes, K., Pambaguian, L., and Menon, C., “Towards the use of mushroom-capped dry adhesives in outer space: Effects of low pressure and temperature on adhesion strength,” Aerospace Science and Technology, Vol. 29, No. 1, 2013, pp. 185-190.
[19] Mate, S., A Friction and Adhesion Characterization Setup for Extreme Temperatures, Ph.D. thesis, Arizona State University, 2016.
[20] Terwisscha-Dekker, H., Grzelka, M., L'epinay, S., & Bonn, D. (2021). How does ‘Gecko tape’ work? Biotribology, 26(100179), ISSN 2352-5738.
[21] King, D. R., Bartlett, M. D., Gilman, C. A., Irschick, D. J., & Crosby, A. J. (2014). Creating Gecko-Like adhesives for “Real world” surfaces. Advanced Materials, 26(25), 4345-4351.
[22] P. Glick, S. A. Suresh, D. Ruffatto, M. Cutkosky, M. T. Tolley and A. Parness, “A Soft Robotic Gripper With Gecko-Inspired Adhesive,” in IEEE Robotics and Automation Letters, vol. 3, no. 2, pp. 903-910, April 2018, doi: 10.1109/LRA.2018.2792688.
[23] Grasping Without squeezing: Design and modeling of Shear-Activated Grippers. (2018 April 1). IEEE Journals & Magazine-IEEE Xplore.
[24] Cauligi, A., Chen, T. G., Suresh, S. A., Dille, M., Ruiz, R. G., Vargas, A. M., Pavone, M., & Cutkosky, M. (2020 September 19). Design and development of a Gecko-Adhesive gripper for the Astrobee Free-Flying Robot. arXiv.org. arxiv.org/abs/2009.09151
[25] Glick, Paul & Suresh, Srinivasan & Ruffatto, Donald & Cutkosky, Mark & Tolley, Michael & Parness, Aaron. (2018). A Soft Robotic Gripper With Gecko-Inspired Adhesive. IEEE Robotics and Automation Letters. PP. 1-1. 10.1109/LRA.2018.2792688.
[26] Interlink Electronics. (n.d.). FSR 402 Data Sheet: FSR 400 Series Round Force Sensing Resistor (P/N: 94-00011 Rev. A). Interlink Electronics-Sensor Technologies.
[27] How does a Force sensing resistor (FSR) work?—TeKScan. (n.d.).
[28] Force Sensitive Resistor (FSR). (2012 July 29). Adafruit Learning System.
[29] FSR Force Sensing Resistor Integration Guide and Evaluation Parts Catalog: 400 Series Evaluation Parts With Suggested Electrical Interfaces (No. 90-45632 Rev. D). (n.d.). Interlink Electronics.
[30] LE HELLEY, A. (2024). SQUID: A multi-axis Gecko Adhesive Grapple: Final year internship dissertation.
[31] Barnhart, D., Andreyeva, K., Topper, H., Lintala, P., & Griffith, T. (2022 October). REACCH Deliverable #2 For USC Subcontract with KMI under Prime Contract FA9453-22-C-A056
[32] Barreau, V., Hensel, R., Guimard, N. K., Ghatak, A., McMeeking, R. M., & Arzt, E. (2016). Fibrillar elastomeric micropatterns create tunable adhesion even to rough surfaces. Advanced Functional Materials, 26(26), 4687-4694.
[33] Olender, J., Perris, J., Xu, Y., Young, C., Mulvihill, D. M., & Gadegaard, N. (2022). Gecko-inspired dry adhesives for heritage conservation-tackling the surface roughness with empirical testing and finite element modelling. Journal of Adhesion Science and Technology, 37(6), 1091-1116.
[34] Stratton, M., Pastizzo, J., MacRae, G., Hill, J., & Barnhart, D. (n.d.). Optimizing element & system compliance of robotic, gecko adhesion-based grippers to the unknown geometries of space debris targets [Session 5. Post Mission Disposal and Space Debris Removal 1-SEM]. IAC-24,A6,5,6,x90620. 75th International Astronautical Congress, Milan, Italy.
[35] US 2021/0094708 A1 Apr. 1, 2021 Patent “Multi-Armed Soft Capture System”, Barnhart et al, USC.
[36] Narayanan, S., Barnhart, D., Rogers, R., Dean, G., Bern-stein, S., Singh, A., Almeida, O., Sampathkumar, S., Maness, E., and Rughani, R. -USC; Ruffatto, D., Schaler, E., Van Crey, N., Bhanji, A., and Junkins, E.-JPL; “REACCH-Reactive Electro-Adhesive Capture ClotH Mechanism to Enable Safe Grapple of Cooperative/Non-Cooperative Space Debris.” 30th AIAA/AAS Space Flight Mechanics Meeting. Orlando, Florida, 6-10 Jan. 2020.
[37] Kall Morris Incorporated. (n.d.). Kall Morris Incorporated.
[38] Hill, J., Lintala, P., & Barnhart, D. (Eds.). (2024). 3DOF Air Bearing Platform As A Testbed For A Gecko Gripper Active Debris Removal Mechanism. IAC-24,A6,IP,1,x90664.
[39] Statton, M. (2024). Optimizing Element & System Compliance of Robotic, Gecko Adhesion-Based Grippers to Unprepared Space Debris Targets [Master's thesis, University of Southern California] doi: doi.org/10.25549/usctheses-oUC11399EHFS.
[40] Tinkercad—From mind to design in minutes. (n.d.). Tinkercad.

What is claimed is:

1. A dry adhesive material comprising:
a gripping layer comprising an adhesive surface defining a plurality of shear-deformable adhesion micro- or nanostructures; and
a compliant backing layer operatively coupled with the gripping layer such that a loading force applied normal to the compliant backing layer causes the plurality of shear-deformable adhesion micro- or nanostructures to electrostatically engage with a target surface.

2. The dry adhesive material of claim 1, wherein the compliant backing layer has a thickness of 1 centimeter (cm) or more.

3. The dry adhesive material of claim 1, wherein the compliant backing layer has a thickness of from 1 cm to 5 cm.

4. The dry adhesive material of claim 1, wherein the compliant backing layer comprises a material having a compressive stiffness of 1 MPa or less.

5. The dry adhesive material of claim 1, wherein the compliant backing layer comprises a material having a Shore A hardness of 50 or less.

6. The dry adhesive material of claim 1, wherein the compliant backing layer comprises a material having an average density of 100 kg/m³ or less.

7. The dry adhesive material of claim 1, wherein the compliant backing layer comprises a porous foam material.

8. The dry adhesive material of claim 1, wherein the compliant backing layer comprises a material selected from the group consisting of elastomers and polymeric foams.

9. The dry adhesive material of claim 8, wherein the polymeric foam comprises polyurethane foam, polyurea foam, polyolefin foam, polyester foam, polystyrene foam, polyether foam, or a copolymer thereof, or a combination thereof.

10. The dry adhesive material of claim 8, wherein the polymeric foam comprises an open cell foam.

11. The dry adhesive material of claim 8, wherein the polymeric foam comprises a closed-cell foam.

12. The dry adhesive material of claim 1, wherein the compliant backing layer comprises a soft silicone rubber.

13. The dry adhesive material of claim 1, wherein the plurality of shear-deformable adhesion micro- or nanostructures comprise directionally-biased micro-wedges.

14. The dry adhesive material of claim 1, wherein the gripping layer comprises a flexible substrate disposed between the adhesive surface and the compliant backing layer.

15. The dry adhesive material of claim 1, wherein a peak shear force of the dry adhesive material is at least 10 N/cm² or more measured at a normal force of 1 N.

16. The dry adhesive material of claim 1, wherein a peak shear force of the dry adhesive material is at least 2 times greater than a peak shear force of a dry adhesive material without a compliant backing.

17. An end effector comprising one or more moveable members, wherein at least a portion of an outer surface of the one or more moveable members comprises the dry adhesive material of claim 1.

18. A robotic system comprising the end effector of claim 17.

19. A method of gripping an object, the method comprising:
positioning the end effector according to claim 17 proximate to an object; and
actuating said end effector to cause at least a portion of the dry adhesive material to contact the object to thereby.

20. A textile comprising the dry adhesive material of claim 1.
